(19) United States
(12) Patent Application Publication
(10) Pub. No.: US 2024/0317127 A1
(43) Pub. Date: Sep. 26, 2024

(54) ARMREST STRUCTURE

(71) Applicants: STARTING INDUSTRIAL CO., LTD., Tokyo (JP); KOMATSU LTD., Tokyo (JP)

(72) Inventors: Hiroki KATO, Tokyo (JP); Ami ISHIMIZU, Tokyo (JP); Tomoshi HIRANO, Tokyo (JP); Norihiro IWAHASHI, Tokyo (JP)

(73) Assignees: STARTING INDUSTRIAL CO., LTD., Tokyo (JP); KOMATSU LTD., Tokyo (JP)

(21) Appl. No.: 18/578,928

(22) PCT Filed: Jun. 30, 2022
(86) PCT No.: PCT/JP2022/026303

§ 371 Date: Jan. 12, 2024

(30) Foreign Application Priority Data
Aug. 5, 2021 (JP) 2021-128764

(51) Int. Cl. B60N 2/75

(52) U.S. Cl. CPC B60N 2/777

(57) ABSTRACT

An armrest structure easily adjustable in position with one hand includes an armrest portion attached to a fixed frame to be swingable horizontally, and the armrest portion includes a button member disposed to be push-operable, at a front end of the armrest portion, and an urging member configured to urge the button member. The fixed frame and the button member regulate swing of the armrest portion by causing a pin provided on one of the fixed frame and the button member to engage with an engagement groove provided on the other of the fixed frame and the button member. The urging member urges the button member in a direction in which the pin and the engagement groove engage with each other. When the button member is pushed in against urging force of the urging member, the pin disengages from the engagement groove to enable the armrest portion to swing.

### TECHNICAL FIELD

The present invention relates to an armrest structure disposed on a side of a seat.

### BACKGROUND ART

A work machine such as a loader and a shovel used for excavating ground and for moving excavated sediment and the like includes a seat in a cab, and an operator sitting on the seat operates operation levers to perform a work. Armrests for reducing a workload of the operator are provided on the seat of such a work machine in some cases. The operator can control the machine in a comfortable position by placing arms on the armrests.

Such armrests are desirably adjustable in position based on physique and preference of the operator. For example, Patent Literature 1 discloses a configuration in which an armrest is laterally swingable by pulling a knob provided on a rear side of the armrest. In the configuration disclosed in Patent Literature 1, when a hand is released from the knob in a state where the armrest is at a desired position, a positioning pin urged by a spring engages with a corresponding reception groove, to fix a lateral position of the armrest.

### CITATION LIST

### Patent Literature

[Patent Literature 1] Japanese Utility Model Laid-Open No. H7-23461

### SUMMARY OF INVENTION

### Technical Problem

To adjust the lateral position of the armrest in the configuration disclosed in Patent Literature 1 described above, the operator moves the armrest with one hand while the operator pulls the knob with the other hand. In other words, the lateral position of the armrest cannot be adjusted with one hand, which deteriorates operability. In addition, after the operator adjusts the armrest with both hands, the operator checks the position of the armrest by placing an arm on the armrest. Therefore, if the position of the armrest is not fit, the operator adjusts the position of the armrest with both hands again, and the positional adjustment may not be finished with a single work.

An object of the present invention is to provide an armrest structure that can solve such issues in the existing structure and is easily adjustable in position with one hand.

### Solution to Problem

To solve the above-described issues, according to the present invention, an armrest structure includes a fixed frame fixed to a side of a seat, and an armrest portion attached to the fixed frame to be swingable in a horizontal direction. The armrest portion includes a button member disposed to be push-operable, at a front end of the armrest portion, and an urging member configured to urge the button member in a direction in which the button member protrudes from the front end of the armrest portion. The fixed frame and the button member regulate swing of the armrest portion by causing a pin provided on one of the fixed frame and the button member to engage with an engagement groove provided on the other of the fixed frame and the button member. The urging member urges the button member in a direction in which the pin and the engagement groove engage with each other. When the button member is pushed in against urging force of the urging member, the pin disengages from the engagement groove to enable the armrest portion to swing.

### Advantageous Effects of Invention

The present invention is as described above. The button member is urged so as to protrude from the front end of the armrest portion. When the button member is pushed in against the urging force of the urging member, the pin disengages from the engagement groove to enable the armrest portion to swing. As described above, since the armrest portion becomes swingable only by pushing the button member at the front end of the armrest portion, the positional adjustment can be easily performed with one hand.

### BRIEF DESCRIPTION OF DRAWINGS

FIG. 1 is an appearance view of a seat.

FIG. 2 is an appearance view of an armrest.

FIG. 3 is a diagram illustrating components of the armrest.

FIG. 4 is a partial enlarged view of an armrest portion mounted with a button member as viewed from obliquely below.

FIG. 5 is a partial enlarged view illustrating a mounting position of the button member and a fixed frame, where FIG. 5(a) is a diagram as viewed from obliquely above, and FIG. 5(b) is a diagram as viewed from obliquely below.

FIG. 6 is a plan view illustrating an internal structure of the armrest, where FIG. 6(a) is a diagram illustrating a state where a pin engages with a first engagement groove, and FIG. 6(b) is a diagram illustrating a state where the pin engages with a second engagement groove.

FIG. 7 is a diagram illustrating a state where the pin moves along a guide groove, where FIG. 7(a) is a diagram illustrating the state where the pin engages with the first engagement groove, FIG. 7(b) is a diagram illustrating a state where the button member is pushed in and the pin disengages from the first engagement groove, FIG. 7(c) is a diagram illustrating a state where the armrest portion swings and the pin moves to a front of the second engagement groove, and FIG. 7(d) is a diagram illustrating the state where the pin engages with the second engagement groove.

### DESCRIPTION OF EMBODIMENT

An embodiment of the present invention is described with reference to drawings. In the following description, an upward direction in a state where a seat 10 is horizontally placed is defined as an “upward” direction, and a downward direction in the state where the seat 10 is horizontally placed is defined as a “downward” direction. A front direction of an operator sitting on the seat 10 is defined as a “forward” direction, and a direction opposite to the “forward” direction is defined as a “rearward” direction. A left side as viewed from the operator sitting on the seat 10 is defined as a “left” direction, and a right side as viewed from the operator is defined as a “right” direction.

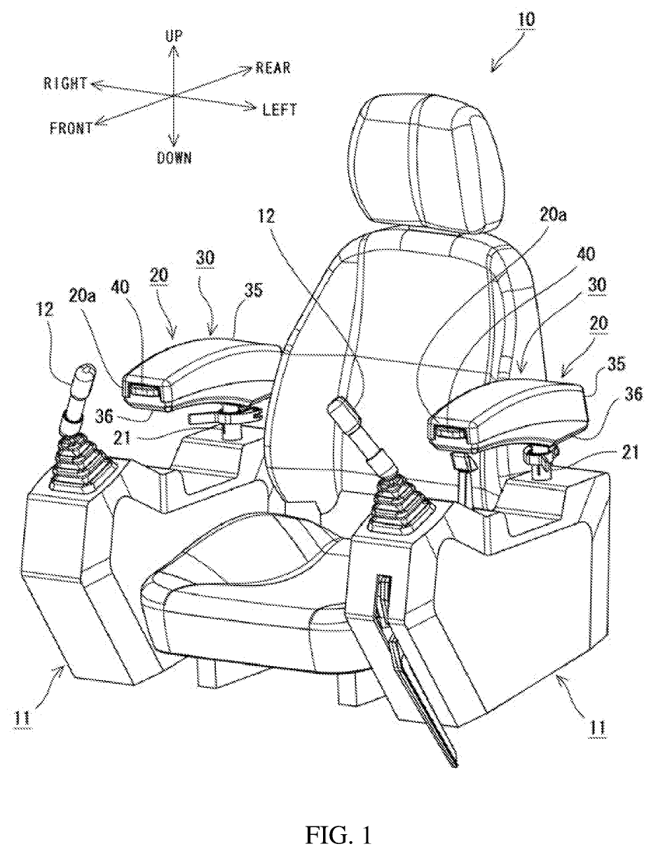

Armrests 20 according to the present embodiment are provided in a work machine (for example, working vehicle such as hydraulic shovel) including the seat 10. Such a work machine includes the seat 10 for the operator as illustrated in FIG. 1 in a cab, and console boxes 11 are provided on respective sides of the seat 10. Operation levers 12 protrude from the respective console boxes 11. The operator operates the operation levers 12 with both hands to laterally turn the machine and to move an arm of the machine.

In the present embodiment, the armrests 20 are mounted on upper parts of the respective console boxes 11. The armrests 20 are disposed on rear sides of the respective operation levers 12. The operator can place arms on the armrests 20 when the operator grips the operation levers 12.

Each of the armrests 20 according to the present embodiment includes a support shaft 21, a fixed frame 25, and an armrest portion 30. Although details are described below, a lateral position of the armrest 20 is adjustable by operating a button member 40 protruding from a front end part 20a.

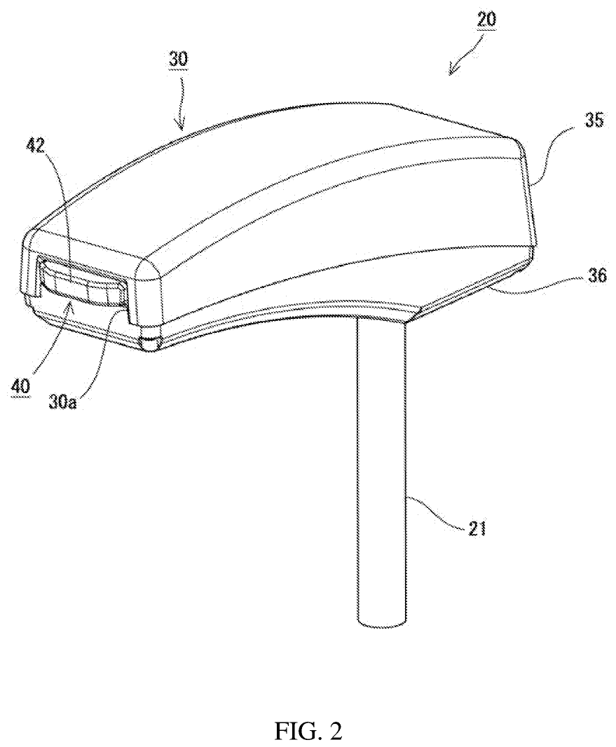

The support shaft 21 is a member supporting the armrest 20. As illustrated in FIG. 1 and FIG. 2, the support shaft 21 according to the present embodiment is a pipe-shaped member perpendicularly disposed, and a lower part of the support shaft 21 is fixed to the corresponding console box 11. The support shaft 21 extends upward from the console box 11, and the fixed frame 25 described below is fixed to an upper end part of the support shaft 21.

The support shaft 21 may be directly fixed to the console box 11, or may be fixed to the console box 11 through another member. For example, an outer-pipe member may be provided on the console box 11 so as to protrude from the console box 11, and the support shaft 21 may be inserted into and fixed to the outer-pipe member. At this time, the outer-pipe member and the support shaft 21 may be fixed by a fixing means such as a clamp mechanism. Furthermore, the support shaft 21 may be vertically slid relative to the outer-pipe member by releasing the fixing means, and may be fixed again at a desired position by the fixing means, thereby changing a height of the armrest 20.

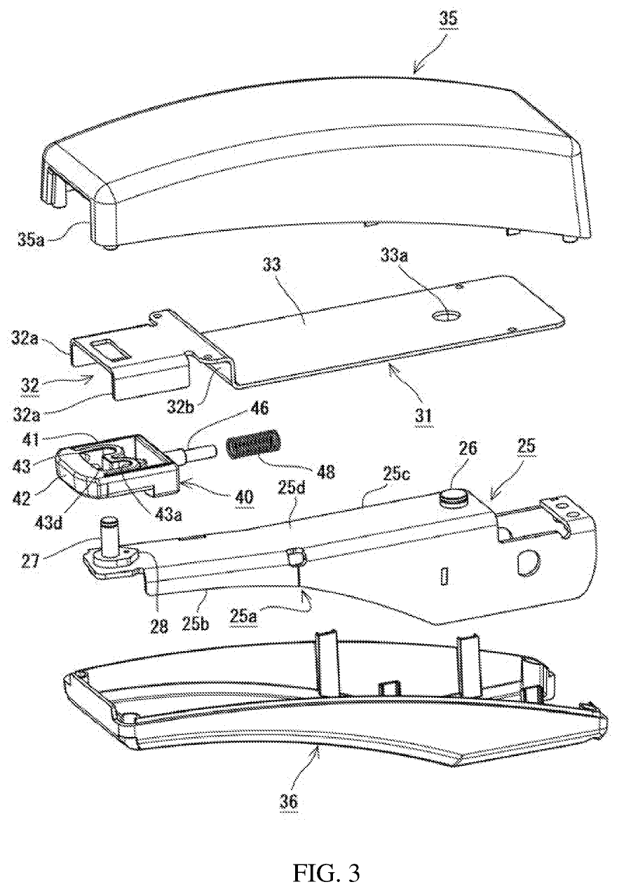

The fixed frame 25 is a member disposed on a side of the seat 10 by being fixed to an upper end of the support shaft 21. The fixed frame 25 is not exposed to outside because of being housed inside the armrest portion 30. The fixed frame 25 is a member supporting the whole of the armrest 20. Therefore, the fixed frame 25 is made of a material having rigidity, such as a metal. As illustrated in FIG. 3, the fixed frame 25 according to the present embodiment has a shape obtained by bending a sheet metal in a downward U-shape.

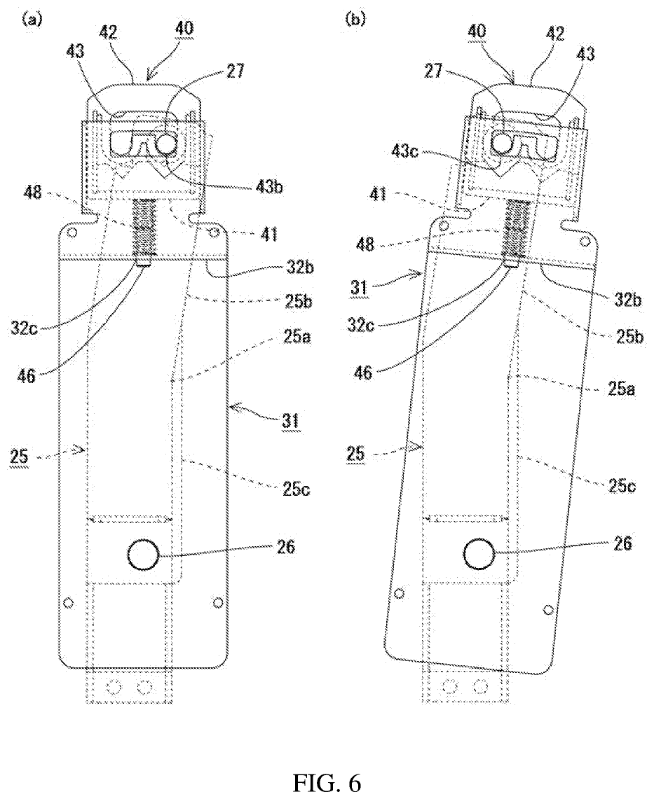

The fixed frame 25 is disposed such that a front-rear direction thereof extends in a longitudinal direction. As illustrated in FIG. 6, the fixed frame 25 is slightly obliquely bent at a bent part 25a provided near a middle in the front-rear direction. A rear portion 25c on a rear side of the bent part 25a extends in parallel with the front-rear direction, whereas a front portion 25b on a front side of the bent part 25a extends while being slightly inclined to any of right and left directions. Even when the armrest portion 30 laterally swings, the fixed frame 25 does not jump out of the armrest portion 30 (fixed frame 25 does not interfere with upper cover 35 and lower cover 36 described below) because the fixed frame 25 is formed in such a shape.

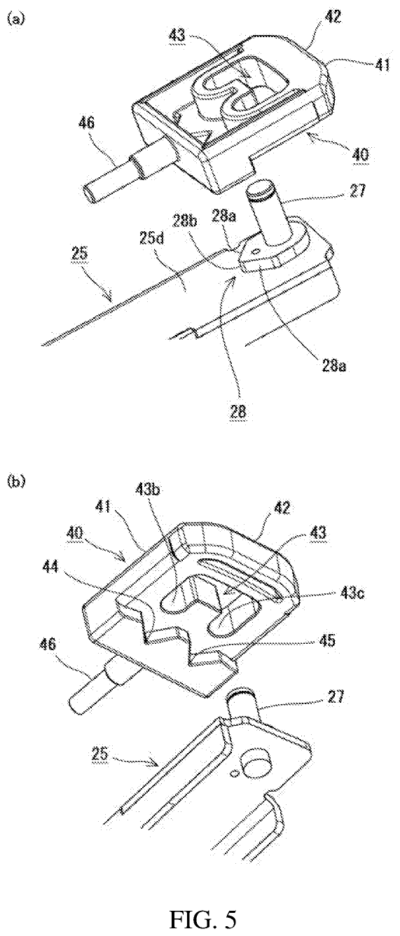

An upper surface of the fixed frame 25 is a horizontal flat surface 25d as illustrated in FIG. 3. A stay 31 described below is attached so as to be laterally slidable along the flat surface 25d. A swing shaft 26 is provided at a position close to a rear side rather than the center in the front-rear direction on the flat surface 25d. The swing shaft 26 serves as a swing center of the stay 31, and protrudes upward from the flat surface 25d. Further, a pin 27 and an engagement protrusion 28 are provided near a front end part of the flat surface 25d. The pin 27 protrudes upward from the flat surface 25d. In other words, the pin 27 extends such that a vertical direction of the pin 27 corresponds to an axial direction. The pin 27 according to the present embodiment has a round rod shape, and is inserted into a guide groove 43 of the button member 40 described below. The engagement protrusion 28 is raised upward from the flat surface 25d at a position near the pin 27. As illustrated in FIG. 5(a), the engagement protrusion 28 includes a tapered corner part 28b that is formed by two perpendicular inclined surfaces 28a, and the corner part 28b protrudes rearward. The engagement protrusion 28 is engageable with engagement concave portions of the button member 40 described below.

The armrest portion 30 is mounted on the above-described fixed frame 25 so as to be swingable in a horizontal direction. As illustrated in FIG. 3, the armrest portion 30 according to the present embodiment includes the stay 31, the upper cover 35, the lower cover 36, the button member 40, and an urging member 48.

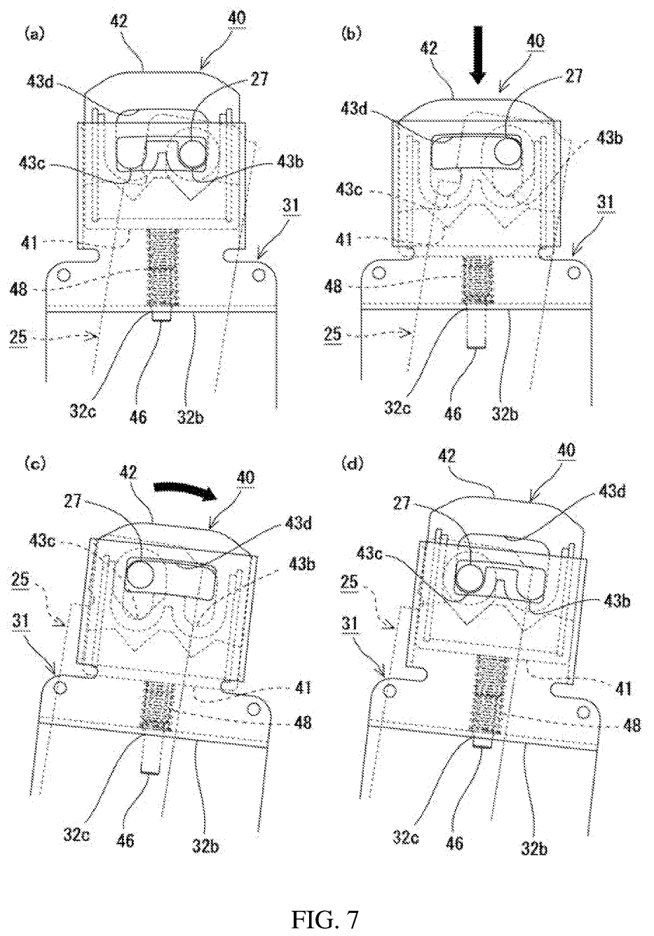

The stay 31 is a member serving as a framework of the armrest portion 30, and is made of a material having rigidity, such as a metal. The stay 31 according to the present embodiment has a shape obtained by bending a sheet metal. The stay 31 includes a button housing portion 32 at a front end part. The button housing portion 32 is a portion for movably housing the button member 40. The button housing portion 32 includes side walls 32a on right and left sides, and a rear wall 32b on a rear side. Therefore, the right, left, and rear sides of the button housing portion 32 are surrounded but a front side is opened. As illustrated in FIG. 7, a through hole 32c allowing a spring attachment shaft 46 (described below) of the button member 40 to pass therethrough is provided in the rear wall 32b. The button housing portion 32 houses the button member 40 such that the button member 40 can protrude forward and can slide in the front-rear direction. The side parts of the button member 40 housed in the button housing portion 32 are guided by the parallel side walls 32a. Thus, the button member 40 is supported without lateral backlash, and is slidable in the front-rear direction.

The stay 31 also includes a plate portion 33 behind the button housing portion 32. The plate portion 33 includes a flat lower surface, and the lower surface is disposed to face the flat surface 25d of the fixed frame 25. The plate portion 33 includes a shaft hole 33a to which the above-described swing shaft 26 is attached. When the swing shaft 26 is attached to the shaft hole 33a, the stay 31 can laterally swing around the swing shaft 26.

The upper cover 35 and the lower cover 36 are members covering mechanism portions such as the fixed frame 25 and the stay 31 described above so as not to be exposed. An upper surface of the upper cover 35 is a smooth surface enabling the operator to place an arm thereon. A notch 35a as illustrated in FIG. 3 is provided at a front end part of the upper cover 35. When the upper cover 35 and the lower cover 35 are assembled, an opening 30a is formed by the notch 35a in a front surface of the armrest portion 30 (see FIG. 2). The button member 40 described below is disposed so as to be retractable through the opening 30a.

The button member 40 is a member operated by the operator to adjust a lateral position of the armrest 20. The button member 40 is disposed to be push-operable at a front end of the armrest portion 30. The button member 40 is disposed above the fixed frame 25 inside the armrest portion 30, and is disposed to be slidable in the front-rear direction along the flat surface 25d of the fixed frame 25. As illustrated in FIG. 5 and other drawings, the button member 40 includes a main body 41 including the guide groove 43, and the spring attachment shaft 46 extending rearward from the main body 41.

As illustrated in FIG. 5, the main body 41 of the button member 40 is formed in a thin plate shape. As illustrated in FIG. 2, a front end part of the main body 41 serves as an operation portion 42 protruding forward from the armrest portion 30. When the operator pushes and operates the operation portion 42, the button 40 slides rearward relative to the fixed frame 25.

The main body 41 of the button member 40 includes the guide groove 43 penetrating through the main body 41 in a vertical direction. As illustrated in FIG. 5(b), the guide groove 43 includes a plurality of engagement grooves 43a, and a connection portion 43d connecting the plurality of engagement grooves 43a. The guide groove 43 according to the present embodiment includes two engagement grooves 43a, namely, includes a first engagement groove 43b and a second engagement groove 43c. The plurality of engagement grooves 43a (first engagement groove 43b and second engagement groove 43c) are provided in parallel to each other, and extend along a sliding direction (front-rear direction) of the button member 40. The connection portion 43d is provided to connect front end parts of the plurality of engagement grooves 43a (first engagement groove 43b and second engagement groove 43c).

As illustrated in FIG. 6, the pin 27 provided on the fixed frame 25 is inserted into the guide groove 43. The guide groove 43 has a width greater than a diameter of the pin 27. Therefore, the pin 27 can move along the guide groove 43, and can move from one of the engagement grooves 43a to the other engagement groove 43a through the connection portion 43d. In addition, the pin 27 can be held by an optional engagement groove 43a. In other words, as illustrated in FIG. 6, the pin 27 can engage with a closed rear end part of the optional engagement groove 43a. When the pin 27 engages with the optional engagement groove 43a, lateral movement of the pin 27 is regulated. As a result, the fixed frame 25 and the button member 40 cannot laterally move relative to each other, and the armrest portion 30 is fixed so as not to swing. As described above, the pin 27 engages with the optional engagement groove 43a, which regulates swing of the armrest portion 30.

A position of the armrest portion 30 in a lateral direction is changed depending on the engagement groove 43a with which the pin 27 engages. In other words, the armrest portion 30 swingable laterally is fixed to an optional position by the pin 27 and the engagement grooves 43a, which makes it possible to adjust the position of the armrest portion 30. In the present embodiment, in a case where the pin 27 engages with the first engagement groove 43b as illustrated in FIG. 6(a), the armrest portion 30 is disposed in parallel to the front-rear direction. In a case where the pin 27 engages with the second engagement groove 43c as illustrated in FIG. 6(b), the armrest portion 30 is disposed obliquely to the front-rear direction. As described above, lateral inclination of the armrest portion 30 is changed depending on the engagement groove 43a with which the pin 27 engages.

In contrast, in a state where the pin 27 engages with no engagement groove 43a, in other words, in a state where the pin 27 is positioned in the connection portion 43d, lateral movement of the pin 27 is not regulated. Therefore, the armrest portion 30 is laterally swingable relative to the fixed frame 25.

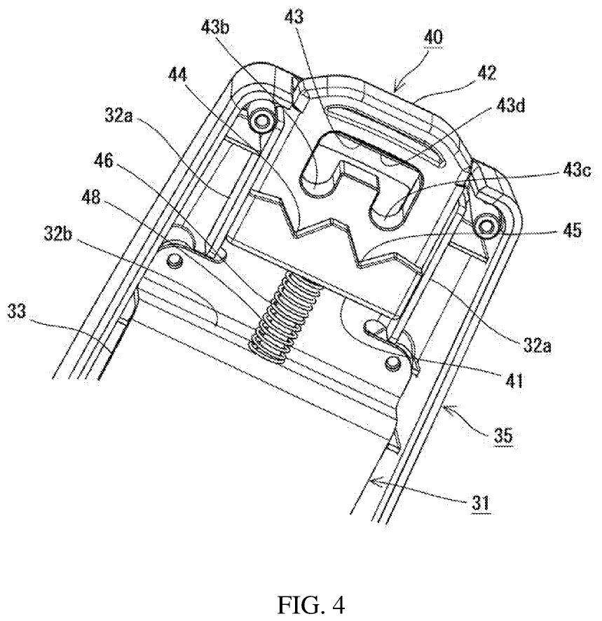

As illustrated in FIG. 4, a plurality of engagement concave portions corresponding to the respective engagement grooves 43a are provided on a lower surface (surface facing fixed frame 25) of the main body 41 of the button member 40. Since the guide groove 43 according to the present embodiment includes two engagement grooves 43a (first engagement groove 43b and second engagement groove 43c), two engagement concave portions are provided corresponding to the two engagement grooves 43a. More specifically, a first engagement concave portion 44 corresponding to the first engagement groove 43b and a second engagement concave portion 45 corresponding to the second engagement groove 43c are provided.

Each of the engagement concave portions is formed in a shape with which the corner part 28b of the engagement protrusion 28 of the fixed frame 25 engages. In other words, each of the engagement concave portions has a recessed corner shape (valley shape) formed by two inclined surfaces, and the recessed corner shape is formed at the angle same as the angle of the corner part 28b of the engagement protrusion 28. Therefore, each of the engagement concave portions can engage with the engagement protrusion 28 without backlash. Each of the engagement concave portions and the engagement protrusion 28 are configured to engage with each other when the pin 27 engages with the corresponding engagement groove 43a. More specifically, when the pin 27 engages with the first engagement groove 43b, the engagement protrusion 28 engages with the first engagement concave portion 44. When the pin 27 engages with the second engagement groove 43c, the engagement protrusion 28 engages with the second engagement concave portion 45. Such a configuration enables the fixed frame 25 and the button member 40 to smoothly engage with each other without backlash.

The spring attachment shaft 46 protrudes rearward from the main body 41 of the button member 40 described above. As illustrated in FIG. 7, the spring attachment shaft 46 passes through the through hole 32c of the stay 31. In addition, the urging member 48 formed of a compression spring is attached on an outer periphery of the spring attachment shaft 46. The urging member 48 is disposed between a rear end surface of the main body 41 of the button member 40 and the rear wall 32b of the stay 31, and urges the rear end surface of the main body 41 of the button member 40 and the rear wall 32b of the stay 31 in a separating direction. As a result, the button member 40 is urged forward relative to the stay 31 so as to protrude from the front end of the armrest portion 30. When the button member 40 is urged forward as descried above, action of pressing the pin 27 against the rear part of the guide groove 43 occurs. In other words, the urging member 48 urges the button member 40 in a direction in which the pin 27 and any of the engagement grooves 43a engage with each other.

In a natural state, the state where the pin engages with any of the engagement grooves 43a is maintained by such action of the urging member 48. On the other hand, when the button member 40 is pushed in against urging force of the urging member 48, the pin 27 disengages from the engagement groove 43a and moves to the connection portion 43d, which enables the armrest portion 30 to swing. The operation at this time is described with reference to FIG. 7.

In the example in FIG. 7, the pin 27 engages with the first engagement groove 43b as illustrated in FIG. 7(a). When the button member 40 is pushed in this state, the pin 27 disengages from the engagement groove 43a and moves to the connection portion 43d as illustrated in FIG. 7(b). When the pin 27 moves to the connection portion 43d, the pin 27 becomes laterally movable. Therefore, the armrest portion 30 becomes laterally swingable relative to the fixed frame 25.

FIG. 7(c) illustrates a state where the armrest portion 30 is manually swung from the state in FIG. 7(b). After the operator swings the armrest portion 30 to a desired position in such a manner, the operator releases pushing operation of the button member 40 (releases hand pushing button member 40). As a result, the button member 40 moves forward by the urging member 48, and the pin 27 accordingly engages with any of the engagement grooves 43a. In the example in FIG. 7(d), the pin 27 engages with the second engagement groove 43c, and the lateral position of the armrest portion 30 is fixed.

The above-described operation is easily performable with one hand. The operator grips the front end part of the armrest portion 30 with one hand, and pushes and operates the button member 40 with the hand gripping the armrest portion 30. In addition, the operator laterally swings the armrest portion 30 while gripping the armrest portion 30, and releases the button member 40 at an optional position, thereby fixing the armrest portion 30.

In the present embodiment, in the above-described operation, the button member 40 and the armrest portion 30 move while the pin 27 is constantly housed in the guide groove 43. In other words, when the button member 40 and the armrest portion 30 move, the pin 27 does not go out of the guide groove 43. This makes it possible to prevent the pin 27 from dropping off from the guide groove 43. In addition, since the pin 27 moves along the guide groove 43, the series of operation is smoothly performable.

As described above, according to the present embodiment, the button member 40 is urged so as to protrude from the front end of the armrest portion 30, and when the button member 40 is pushed in against the urging force of the urging member 48, the pin 27 disengages from the engagement groove 43a, and the armrest portion 30 becomes swingable. As described above, since the armrest portion 30 becomes swingable only by pushing the button member 40 at the front end of the armrest portion 30, the positional adjustment can be easily performed with one hand. More specifically, when the operator grips the front end of the armrest portion 30 while placing the arm on the armrest portion 30, the operator can naturally push the button member 40. Further, since the position of the armrest portion 30 is adjustable while the arm is placed on the armrest portion 30, the operator can simultaneously perform adjustment and check of the position of the armrest portion 30.

In the present embodiment, the button member 40 is urged so as to protrude from the front end of the armrest portion 30; however, the button member 40 does not necessarily protrude from the front end of the armrest portion 30. For example, the button member 40 may be provided to be flush with the front end of the armrest portion 30, and the engagement groove may be disengaged by pressing the button member from the opening 30a at the front end of the armrest portion 30.

In the above-described embodiment, the case where the number of engagement grooves 43a is two is described; however, the number of engagement grooves 43a is not limited thereto, and three or more engagement grooves 43a may be provided. At this time, the number of engagement concave portions may be increased so as to match with the number of engagement grooves 43a.

In the above-described embodiment, the pin 27 is provided on the fixed frame 25, and the engagement grooves 43a are provided in the button member 40; however, the configuration is not limited thereto, and the engagement grooves 43a may be provided in the fixed frame 25, and the pin 27 may be provided on the button member 40. In such a case, the engagement grooves 43a are formed in shapes inverted in the front-rear direction.

In the above-described embodiment, the engagement protrusion 28 is provided on the fixed frame 25, and the engagement concave portions are provided on the button member 40; however, the configuration is not limited thereto, and the engagement concave portions may be provided on the fixed frame 25, and the engagement protrusion 28 may be provided on the button member 40.

In the above-described embodiment, only one engagement protrusion 28 is provided, and the plurality of engagement concave portions are provided; however, the number of engagement protrusions and the number of engagement concave portions are not limited thereto, and are optionally settable. In other words, the plurality of engagement protrusions may be provided or only one engagement concave portion may be provided as long as any of the engagement protrusions and the engagement concave portion engage with each other when the pin 27 engages with any of the engagement grooves 43a.

### REFERENCE SIGNS LIST

10 Seat
11 Console box
12 Operation lever
20 Armrest
20a Front end part
21 Support shaft
25 Fixed frame
25a Bent part
25b Front portion
25c Rear portion
25d Flat surface
26 Swing shaft
27 Pin
28 Engagement protrusion
28a Inclined surface
28b Corner part
30 Armrest portion
30a Opening
31 Stay
32 Button housing portion
32a Side wall
32b Rear wall
32c Through hole
33 Plate portion
33a Shaft hole
35 Upper cover
35a Notch
36 Lower cover
40 Button member
41 Main body
42 Operation portion
43 Guide groove
43a Engagement groove
43b First engagement groove
43c Second engagement groove
43d Connection portion
44 First engagement concave portion
45 Second engagement concave portion
46 Spring attachment shaft
48 Urging member

1. An armrest structure, comprising:
a fixed frame fixed to a side of a seat; and
an armrest portion attached to the fixed frame to be swingable in a horizontal direction, wherein
the armrest portion includes a button member disposed to be push-operable, at a front end of the armrest portion, and an urging member configured to urge the button member in a direction in which the button member protrudes from the front end of the armrest portion,
the fixed frame and the button member regulate swing of the armrest portion by causing a pin provided on one of the fixed frame and the button member to engage with an engagement groove provided on the other of the fixed frame and the button member,
the urging member urges the button member in a direction in which the pin and the engagement groove engage with each other, and
when the button member is pushed in against urging force of the urging member, the pin disengages from the engagement groove to enable the armrest portion to swing.

2. The armrest structure according to claim 1, wherein
a guide groove including a plurality of the engagement grooves and a connection portion connecting the plurality of engagement grooves is provided, and
the button member and the armrest portion move while the pin is housed in the guide groove.

3. The armrest structure according to claim 1, wherein
one of the fixed frame and the button member includes an engagement protrusion including a tapered corer part, and the other of the fixed frame and the button member includes an engagement concave portion with which the corner part of the engagement protrusion engages, and
the engagement protrusion is configured to engage with the engagement concave portion when the pin engages with the engagement groove.

4. The armrest structure according to claim 2, wherein
one of the fixed frame and the button member includes an engagement protrusion including a tapered corer part, and the other of the fixed frame and the button member includes an engagement concave portion with which the corner part of the engagement protrusion engages, and
the engagement protrusion is configured to engage with the engagement concave portion when the pin engages with the engagement groove.
